(19) United States
(12) Patent Application Publication
(10) Pub. No.: US 2025/0111966 A1
(43) Pub. Date: Apr. 3, 2025

(54) ENHANCED COMPOSITE WRAPPED SURGE ARRESTER AND METHODS OF PROVIDING THE SAME

(71) Applicant: Hitachi Energy Ltd, Zürich (CH)

(72) Inventors: Jeffrey Joseph KESTER, Bemus Point, NY (US); Remo MUGWYLER, Pittsburgh, PA (US)

(21) Appl. No.: 18/978,109

(22) Filed: Dec. 12, 2024

Related U.S. Application Data
(63) Continuation of application No. PCT/EP2023/065639, filed on Jun. 12, 2023.
(60) Provisional application No. 63/351,497, filed on Jun. 13, 2022.

(51) Int. Cl. H01C 1/032; H01C 7/12

(52) U.S. Cl. CPC H01C 1/032; H01C 7/12

(57) ABSTRACT

A solid dielectric surge arrester includes a hermetically sealed composite encased module assembly. The module assembly includes at least one metal oxide varistor (MOV) block with an outer circumferential surface, and a material applied to the outer circumferential surface. The material includes multiple layers to allow the module assembly to withstand a bending moment under long term cyclic load and short term rated bending load, the material is configured to improved bending strengths, and provide safe short circuit failure mode venting in a preferential direction or directions.

### CROSS REFERENCE TO RELATED APPLICATIONS

This application is a continuation application of PCT International Application No. PCT/EP2023/065639 filed on Jun. 12, 2023, which in turn claims domestic priority to U.S. Provisional Patent Application No. 63/351,497, filed on Jun. 13, 2022, the disclosures and content of which are incorporated by reference herein in their entirety.

### BACKGROUND

Lightning or surge arresters are typically connected to power lines to carry electrical surge currents to ground. In this manner, damage to lines and equipment connected close to the arresters may be reduced and/or prevented. During normal system voltage across power lines, arresters have very high resistance and function equivalent to insulators. As system disturbances occur, such as direct and/or indirect lightning surges, switching surges or voltages rise the arresters reach a threshold voltage where the resistance becomes very small and surge currents are conducted to ground through the arrester thus clamping and limiting voltage rise on the system. Examples of common system disturbances include lightning strikes, switching surge currents and temporary over voltages, which can occur from various fault conditions ranging from system insulation failure to tree branches causing a high impedance connection to ground. Typical practice is to use surge arresters to protect system components from dangerous transient over-voltage conditions.

Electrical transmission and distribution equipment are subject to voltages within a narrow and controlled range under normal operating conditions. However, system disturbances, such as lightning strikes and switching surges and systems faults cause momentary or extended over voltage conditions that greatly exceed the levels experienced by the equipment during normal operating conditions. These voltage variations often are referred to as over-voltage conditions.

If not protected from over-voltage conditions, critical and expensive equipment, such as transformers, switching devices, computer equipment, and electrical machinery, may be damaged or destroyed by either the over-voltage conditions or associated current surges. Surge arresters may be used to protect system components from dangerous over-voltage conditions.

After the surge, the voltage drops and the arrester normally returns to a high resistance state. However, upon arrester overload or malfunction, the high resistance state may not be resumed and the arrester may continue to provide an electrical path from the power line to ground. Ultimately, the arrester will fail as currents evolve into a short circuit condition as the metal oxide varistor elements heat up and the arrester will require replacement. For improved system reliability, a need exists to replace the conventional surge arrester.

### SUMMARY

Embodiments herein are directed to a surge arrester that includes a module assembly including at least one metal oxide varister (MOV) block including a top surface, a bottom surface that is opposite the top surface, and an outer circumferential surface between the top and bottom surfaces. A first fabric material is formed onto the outer circumferential surface and that includes a fabric that includes multiple unidirectional glass fibers that are arranged substantially parallel to one another and extend from the bottom surface to the top surface.

Embodiments include a second fabric material that is formed on a portion of the first material. The second fabric material is configured to partially wrap around the first fabric material to define an axially extending gap in the second fabric material. Some embodiments provide that the second fabric material comprises a multi-directional fabric. In some embodiments may include a hoop and/or off axis fibers. In some embodiments, a non-limiting example of the second fabric comprises an 18 oz/square yard fabric0/90 woven and having heavy TOWs' such as, for example, having 4×5 tows per inch. In some embodiments, the fabric may be a +/−45 woven and/or may be stitched and/or layered material.

Embodiments herein are directed to methods of providing a surge arrester. Such method include operations of providing a stack array that includes at least one MOV and at least one metallic block that are arranged adjacent one another to form an outer circumferential surface between a stack top surface and a stack bottom surface. Operations include compressing the stack array by applying an axial compression force at the stack top surface and the stack bottom surface and applying a first fabric material to the outer circumferential surface of the stack array. In some embodiments, the compressive force is maintained through the resin curing operation. The first fabric material includes a fabric that comprises multiple unidirectional glass fibers that are arranged substantially parallel to one another. Operations include applying a second fabric material that is formed on a portion of the first fabric material. In some embodiments, the second fabric material is configured to partially wrap around the first fabric material to define an end-to-end axially extending gap in the second fabric material. Some embodiments include applying a spiral wrap layer over the second fabric material. In some embodiments, the spiral wrap layer includes multiple filament wound hoops.

### BRIEF DESCRIPTION OF THE DRAWINGS

The accompanying drawings, which are included to provide a further understanding of the disclosure and are incorporated in a constitute a part of this application, illustrate certain non-limiting embodiments of the disclosure. In the drawings:

FIG. 1 is a schematic block diagram illustrating an electrical system in which electrical equipment is protected by a surge arrester according to embodiments herein.

FIG. 2 is a block diagram of a surge arrester according to some embodiments.

FIGS. 3A-3E are schematic block diagrams illustrating a cut-away cross-sectional views of respective embodiments of a surge arrester according to some embodiments.

FIG. 4 is a schematic block diagram illustrating a stack array in a module assembly according to some embodiments.

FIG. 5 is a block diagram illustrating operations for providing a surge arrester according to some embodiments.

FIGS. 6A and 6b are schematic block diagrams of a cut-away side view and a top view, respectively of a surge arrester according to some embodiments.

### DETAILED DESCRIPTION

Embodiments will now be described more fully hereinafter with reference to the accompanying drawings, in which examples of embodiments of the disclosure are shown. Embodiments of the disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

A solid dielectric arrester suitable for use in substation, transmission, and distribution surge arrester applications is described. As discussed below, material layers provide axial strength to a solid dielectric arrester while also facilitating the venting of gases and/or plasmas that may be created upon arrester failure or malfunction. As a result, the solid dielectric arresters discussed herein may be used in high-voltage applications and/or applications that require the arrester to withstand significant mechanical forces. Additionally, the material layers may be configured such that under failure mode conditions the solid dielectric arrester permits venting of gases and/or plasmas in specific single or multiple desired directions. These desired specific directions may be considered preferential directions.

Some systems employ hollow-core arresters for high-voltage and/or high-strength applications. Hollow-core arresters may include a housing (such as a reinforced plastic tube) that contains the components of the arrester and provides cantilever strength to the arrester. In a hollow-core arrester, the internal components of the arrester (such as a stack of metal oxide varistors or MOVs) are held away from the wall of the housing such that there is an air space between the internal components and the housing wall. The presence of the air space may allow humid air into the arrester, resulting in moisture ingress to the MOV blocks and other internal components, increasing the probability of degraded performance and arrester failure.

In contrast, solid dielectric arresters may not employ a housing that is separate from the internal components of the arrester. Instead, the internal components of a solid dielectric arrester may be held structurally in place, at least in part, by composites that are bonded to outer circumferential surfaces of the MOV blocks to create a substantially air-free interface between the outer circumferential surface of the MOV blocks and the composites and between a weatherproof polymer housing of the arrester and the composite. As compared to hollow-core arresters, solid dielectric arresters may be easier to produce and may be more reliable due to the absence of the air space and the separate housing. However, because there is no separate tube housing of greater diameter, solid dielectric arresters may have lower cantilever strength than hollow-core arresters as the stresses of bending moment proportionally increase relative to reduction of the composite structure position from center. Additionally, as MOV technology improves the MOV block core diameter may be reduced leading to further increases in mechanical stress on the composite, which may lead to a need for improved composite strength construction methods and materials as disclosed herein.

Some embodiments disclosed may achieve high strength solid dielectric arrester construction. However, introduction of international product standards requiring survival of cyclical loading may render some of those designs as non-compliant and/or substantially reduced in rated bending moment. Some embodiments disclosed herein may enable survival of cyclical loading duty and provide further improvements to bending strength over existing technology.

In a solid dielectric arrester, arrays of metal oxide varistors (MOV blocks) and conductive spacers, and conductive end terminals may be held together under compressive preloads both to provide electrical contact between components and mechanical strength. In service, application of high bending moments may cause the component stack to lift on the tensile side, in turn causing edge to edge contact on the compression side. Some industry standards now provide rated long term cyclic load capacity (SLL) as well as higher rated short term static load capacity (SSL). Some embodiments provide that as the alternating compressive loads occur during cyclic SL, material fatigue related mechanical fracture of the components and/or composite material layers may occur, potentially leading to failure. Also, the quality of electrical contact among the various internal components may be reduced through the lifting effect, and internal partial discharges and/or poor current distribution during fault conditions may occur. Both conditions may lead to permanent damage and/or failure of the arrester. As a result, conventional solid dielectric arrestors may not be optimally suited for high-voltage applications and/or applications that subject the solid dielectric arrester to high mechanical forces.

The cantilever strength of a solid dielectric arrester may be improved through providing higher axial compression preloads on the MOV and Spacer stack continuously during the manufacturing process through composite cure. The compressed stack (MOV, conductive spacer, and terminal stack with over wrapped composite layers) is circumferentially wrapped with compression fabric layers achieving improved densification of the composite layers (fiber and resin) during composite cure. Utilization of the unique spiral circumferential wrapped fabric compression material results both in increased compression on composite fibers as well as increasing the pre-tensioning of composite fibers. Additionally, through use of higher modulus composite glass fibers such as discussed herein, bending stiffness may be further improved. In some embodiments, the composite material is made of a fiber reinforced resin matrix material. The material layers may be configured to provide sufficient axial strength to allow the arrester to withstand demanding conditions while also allowing the arrester to vent gases and/or plasmas to escape upon failure or malfunction resulting with a physically intact structure. Short circuit current ratings can be further increased through application of filament wound hoops on the composite surface. For example, arrangement of multiple axial unidirectional layers applied to the surface of the MOV and component stack may result in high axial strength in the base layer regions while providing no significant hoop strength. These layers are easily separated as temperature rises during end-of-life events, causing decomposition of the resin matrix and creating fiber-to-fiber openings to serve as venting regions. The alignment of the fibers placed over the unidirectional layers and nearer the surface are multi directional, each multi direction layer provides significant resistance to arc pressure relief and therefore applied at less than full circumferential wraps, forming a small gap along each axial butt joint, the start and end of each multidirectional layer is staggered such that bonded layer to layer lap joints are formed to provide adequate hoop strength during bending stress while still having maintaining relatively weak resin rich layer to layer bonding facilitating relatively weak adhesive bonded venting points in these specific areas during end of life failure mode resulting in a solid dielectric arrester that is suitable for use in substation, transmission, and distribution surge arrester applications that require the solid dielectric arrester to withstand high mechanical forces (e.g., a constant, or nearly constant terminal load capacity of 500-1000 lbs. or greater as well as lesser cyclic loads). Applications can require a solid dielectric arrester longer than about 12 feet, and/or applications that subject the solid dielectric arrester to bending moments of up to approximately 100,000 inch-lbs. or higher. Relative to many solid dielectric products, for a given MOV diameter, strengths can be expected to be at least 50% increased.

As discussed in more detail below, the material layer may include multiple layers of a material that include fibers arranged such that, when the material is applied to the MOVs, most of the fibers are aligned with the axial direction of the MOVs. Considering the MOV and spacer core are preloaded in compression as a ridged core, such an arrangement of unidirectional fibers allows the material to be layered onto the surface of the MOV, thus providing cantilever strength, while also allowing venting of gases and/or plasmas from the surge arrester. In contrast, applying many layers of existing composite materials that include approximately equal amounts of fibers in multiple directions may result in diminished (or no) venting of gases. For example, overlapping layers of materials that include fibers in multiple directions may result in the fibers of one layer blocking a fiber-free, or relatively fiber-free, region of an underlying layer. Insufficient venting may cause the arrester to explode or rupture, causing expulsion of the MOV and other components within the arrester and leading to destruction of nearby equipment.

An important improvement to strength is made through the use of permanently applied compression layer fabrics. These fabrics are applied under high tension in of at least 100 to 500 lb/inch, creating radial compression and promoting improved composite material consolidation. These compression fabric layers can be placed within intermediate layers of the composite structure and also on the surface of the composite structure and are adsorbed within the excess available resin matrix material which becomes available as the composite consolidates due to the compressive loads applied. Even further improvement to cyclic loading strength may be achieved by surface treating the conductive metal end electrodes through use of chemical etch or laser etch to remove oxide from the surface layer and also residual oils and other contamination. Some embodiments provide that film or shrink film materials that could only apply 10-20 lb/inch and also inhibit resin flow out of the composite layers providing lesser levels of composite packing and much lower relative strength with greatly reduced cyclic fatigue strength.

In some implementations, a venting region is formed in the material layer such that the solid dielectric arrester is capable of directionally venting gases in a predictable direction. The specific predictable direction may be one or more desired directions and/or one or more particular directions. Directional venting allows, for example, vented gases to be constrained to a particular direction(s) or desired directions(s) such that the vented gases are directed away from adjacent or nearby equipment and/or adjacent phases, thus reducing and/or eliminating collateral damage resulting from a malfunction or failure of the solid dielectric arrester. Some prior art attempts to achieve directional venting relied on breaking through continuous cigarette wrapped layers which were thinner along the top to bottom direction and in a single direction. However, much more plasma gas pressure was required to break through the glass reinforcement resulting in much higher levels of demonstration. By making the layer-to-layer epoxy lap joint the weak breakthrough region the venting location, much lower pressure build up is required. Also, by additionally utilizing arc horns aligned along the axis of predicted failure, the level of demonstration is significantly reduced (plasma cloud size). The venting region is a region in the material layer that is modified such that gases created upon failure or malfunction of the surge arrester escape through the venting region.

In one general aspect, a solid dielectric surge arrester may include a module assembly. The module assembly includes at least one metal oxide varistor (MOV) block with an outer circumferential surface. The solid dielectric surge arrester also includes a composite reinforcing material applied to the outer circumferential surface, the composite reinforcing material including multiple layers to allow the module assembly to withstand a bending moment under a substantially continuously applied load, and the material being configured to allow venting of gas that forms in the module assembly upon failure of the module assembly. In another aspect, a solid dielectric surge arrester includes a module assembly. The module assembly includes at least one metal oxide varistor (MOV) block with an outer circumferential surface, and a material applied to the outer circumferential surface. The material includes multiple layers to allow the module assembly to withstand a bending moments under cyclic loads, and the material is configured to allow venting of gas that forms in the module assembly in a desired direction and/or in multiple desired directions.

Some embodiments may include one or more of the following elements. Some embodiments include a venting region along one or more axial directions of the module assembly. The venting region may allow the venting of gas unidirectionally and/or multi-directionally, and the venting region may be defined by a boundary or boundaries formed by layer-to-layer labyrinth structure in the composite material where there exists a resin only path through the composite layered structure. The boundary and/or boundaries in the material may have a length or lengths that are equal to or greater than the axial length of the MOV block. Gas may vent radially outward through the boundary and perpendicular to the module assembly. A second fabric material may be applied to an outer surface of the material in the form of bands that are configured to constrain the composite layer while allowing venting of gas.

The composite material that includes multiple layers may allow the module assembly to withstand a bending moment greater than 20,000 in-lbs per inch of MOV radius. With larger and larger numbers of unidirectional layers and potentially multiple compression material layers, bending moments can continue to increase approximately proportional to the increase in total unidirectional material thickness.

In some aspects, a solid dielectric surge arrester includes a module assembly that includes at least one metal oxide varistor (MOV) block with an outer circumferential surface, and bidirectional or multidirectional material layers of staggered butt joint locations applied to the outer circumferential surface. In some embodiments, the material layer includes layer to layer epoxy lap joints configured to allow venting of gas that forms in the module assembly upon failure.

Yet another aspect, resin impregnated composite tow and/or tape may be added on the surface of the composite layers to form spaced hoops which function to hold the venting layers in place during failure mode venting from short circuit failure events.

Some embodiments include may include one or more of the following features. The material layer may include a first fabric material applied to the outer circumferential surface of the at least one MOV, and a second fabric material applied to the first fabric material, the second fabric material being wrapped in layers having staggered butt joints and surrounding the first fabric material. Depending on material build thickness, single or multiple compression materials may be applied over all the composite fabric layers or alternatively also within intermediate layer positions.

In some embodiments, a method of assembling a solid dielectric surge arrester includes applying a material to a circumferential surface of a metal oxide varistor (MOV) block, the material configured to allow surge arrester to withstand a bending moment under an approximately continuously applied load, and, forming, with the material, a material layer around the MOV block.

When applied in dry indoor environments, the composite encasements provide adequate dielectric strength and insulation. However, to survive in outdoor environments subject to rain and pollution, it may be beneficial to provide yet another dielectric encasement of silicone or other insulating rubber. While encasements can be interference stretch fit, or clearance fit with intermediate gap filling materials, it may be desired to apply a layer if silane-based primer and then a direct molded and bonded high temperature vulcanized silicone housing.

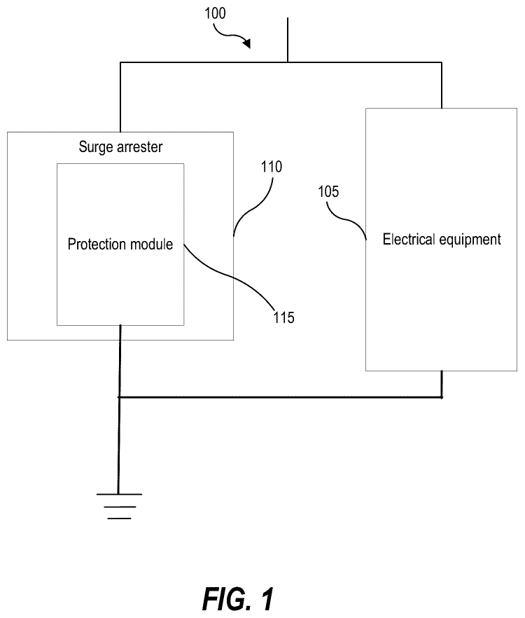

Reference is now made to FIG. 1, which is a schematic block diagram illustrating an electrical system in which electrical equipment is protected by a surge arrester according to embodiments herein. Referring to FIG. 1, an electrical system 100 includes electrical equipment 105 that is protected by a surge arrester 110. In implementations where the electrical equipment can be exposed to very high energy associated with switching events on the electrical equipment 105, the surge arrester 110 may be a station class surge arrester that is capable of protecting the electrical equipment 105. In use and operation, the surge arrester 110 shunts or diverts over-voltage-induced current surges safely around the electrical equipment 105 to ground, and thereby protects the equipment 105 and its internal circuitry from damage. The surge arrester 110 includes a protection module (module assembly) 115 that directs current to or away from the electrical equipment 105 based on the voltage to which the module assembly 115 is exposed. In other words, the module assembly 115 causes current to flow through the surge arrester 110 during periods of over-voltage. The surge arrester 110 is connected in parallel with the electrical equipment 105. Furthermore, in implementations where the energy becomes excessive, a station class surge arrester may be capable of withstanding 80 kA fault currents for 12 cycles.

The module assembly 115 may include a stack (e.g., a stack array) of one or more voltage-dependent, nonlinear resistive elements that are referred to as varistors. An example of a varistor is a metal oxide varister (MOV) block. A varistor is characterized by having a relatively high resistance when exposed to a normal operating voltage, and a much lower resistance when exposed to a larger voltage, such as is associated with over-voltage conditions. The module assembly 115 also may include one or more electrically conductive spacer elements coaxially aligned with the varistors as components of the stack array.

As a result of the varistors, the module assembly 115 may operate in a low impedance mode that provides a current path to electrical ground having a relatively low impedance when exposed to an over-voltage condition. The module assembly 115 otherwise operates in a high impedance mode that provides a current path to ground having a relatively high impedance. When the surge arrester 110 is operating in the low-impedance mode, the impedance of the current path to ground is substantially lower than the impedance of the equipment 105 being protected by the surge arrester 110. As a result, current flows through the current path to ground. The impedance otherwise is substantially higher than the impedance of the protected equipment 105, such that current flows through the electrical equipment 105. Upon completion of the over-voltage condition, the surge arrester 110 returns to operation in the high impedance mode in which the impedance of the module assembly 115 is relatively high. This prevents normal current at the system frequency from following the surge current to ground along the current path through the surge arrester 110.

In some implementations, the electrical equipment 105 may be a transformer that converts a voltage on an input to the transformer to a corresponding voltage on an output of the transformer. For example, the transformer may be included in a substation that also includes the surge arrester 110.

In such applications, the outside of the module assembly 115 may include one or more relatively thin layers of pre-impregnated composite. The pre-impregnated composite layer provides the dielectric module assembly 115 with sufficient mechanical strength to withstand fault current events typical of station class surge arresters while reducing the amount of material used in the station class surge arrester 110, the overall diameter of the module assembly 115, and the size of the surge arrester 110.

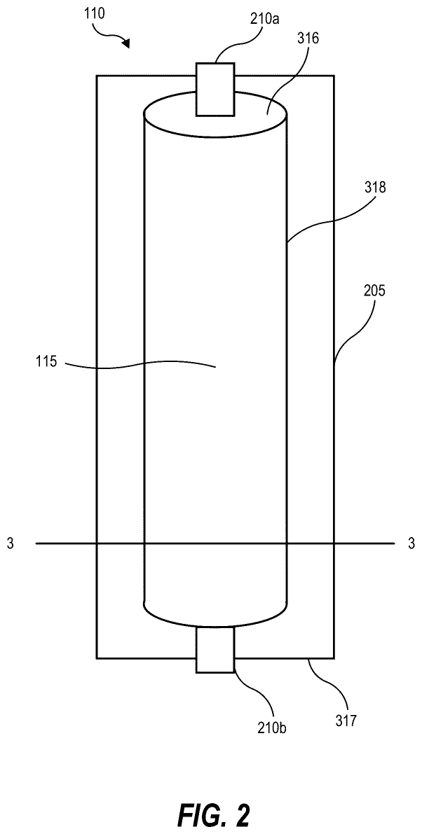

Reference is now made to FIG. 2, which is a block diagram of the surge arrester of FIG. 1. Referring to FIG. 2, the surge arrester 110 includes a housing 205 in which the module assembly 115 is located. The housing 205 may protect the surge arrester 110 from environmental conditions and may be made of an electrically insulating polymeric material. An insulating and/or dielectric compound, such as room temperature vulcanized silicone, may fill any voids between the module assembly 115 and the inner surface of the housing 205.

In some embodiments, the housing assembly is premolded the module is coated with room-temperature-vulcanizing silicone (RTV). The housing may be dilated and collapsed onto the module. In some embodiments, a silane surface treatment is applied onto 115 and then high temperature vulcanized (HTV) silicone 205 may be directly molded and bonded to module 115. This approach could also be done using liquid silicone molding (LSR).

A contact 210a is disposed in an upper terminal near the top of the surge arrester 110. Similarly, a contact 210b is disposed in a lower terminal near the bottom of the surge arrester 110. The upper terminal and the lower terminal connect to the module assembly 115 and extend out of the housing 205 to provide a series electrical path through the surge arrester 110 from the contact 210a to the contact 210b.

In some embodiments, the arrester modules may include molding “logs” of arrester modules. A log according to such embodiments may include 1-10 arrester modules depending on the module size. After molding, the silicone and f/g composite are slit at each module to module interface and separated into individual modules. Therefore, the molded silicone is only encasing the circumferential surface same as the f/g composite. We then use RTV silicone to bond a metal, such as, for example, stainless steel, cap on each end. A terminal stud may be threaded into the module end electrode on each end and retains the metal cap to form a bonded seal. In some embodiments, the RTV may be a gap filler to eliminate entrapped air and also bond the surfaces together.

The surge arrester 110 is connected to a line-potential conductor at the contact 210a and to ground at the contact 210b. The surge arrester 110 also is connected to electrical equipment protected by the surge arrester at the contact 210a. More particularly, an end of the surge arrester 110 and an end of the electrical equipment 105 that are both connected to the line-potential conductor are connected at the contact 210a. The housing 205 is sealed about the upper and lower ends of the module assembly 115.

The module assembly 115 may include one or more MOV blocks and/or conductive blocks that are contained within a pre-impregnated composite structure. The pre-impregnated composite may include a fabricated matrix of fiberglass bundles, and the space between the fiberglass bundles is filled with an epoxy resin. The pre-impregnated composite may be applied around the MOV blocks multiple times. In some embodiments, a scrim layer may be applied over the pre-impregnated composite. The scrim layer may include epoxy resin and a polyester matting that provides a framework to the epoxy resin. The scrim layer provides additional resin to assure that the module assembly 115 is an air-free, solid dielectric module.

Some embodiments provide that the module assembly 115 includes a top surface 316 and a bottom surface 317 that is opposite the top surface 316. Some embodiments provide that the multiple blocks in the stack array define an outer circumferential surface 318 that is between the top and bottom surfaces 316, 317.

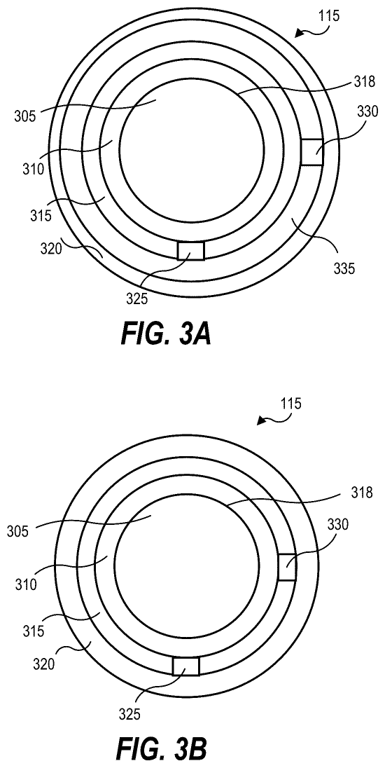

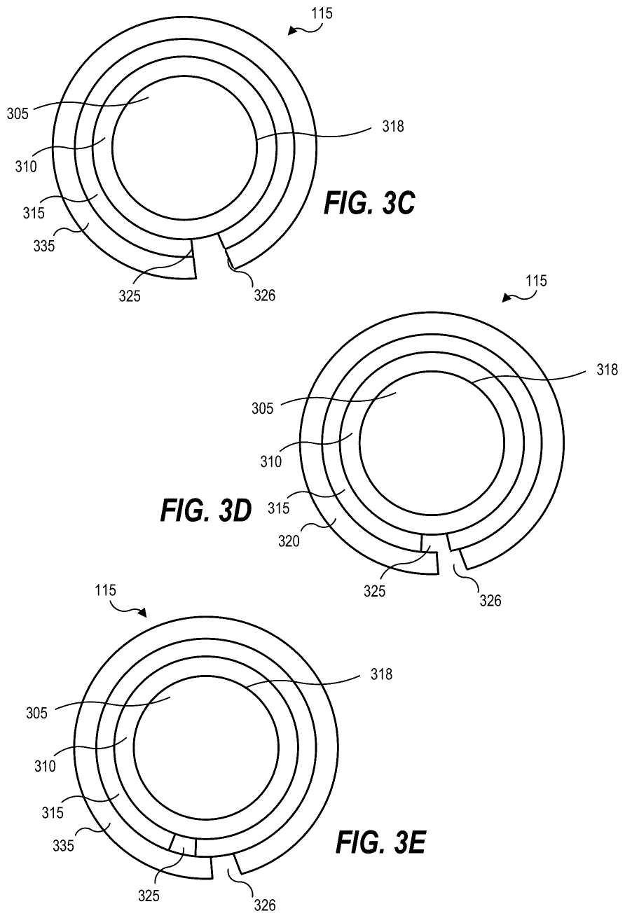

Reference is now made to FIGS. 3A-3E, which are schematic block diagrams illustrating a cut-away cross-sectional views of respective embodiments of a surge arrester component according to some embodiments. Referring to FIG. 3A, a surge arrester 110 may include a module assembly 115 that includes at least one metal oxide varister (MOV) block including the top surface 316, a bottom surface 17 that is opposite the top surface 316, and an outer circumferential surface 318 between the top and bottom surfaces 316, 317. In some embodiments, the MOV block 305 may have a geometry of a disc that is substantially cylindrical, a polygon and/or a rectilinear block.

Some embodiments provide that a first fabric material 310 is formed onto the outer circumferential surface 318 and includes a fabric that includes multiple unidirectional glass fibers that are arranged substantially parallel to one another and extend from the bottom surface 317 to the top surface 316. In some embodiments, after the first fabric is applied, multiple layers of compression tape may be applied. For example, in some embodiments, 6-8 layers of compression tape may be applied. In some embodiments, a Basalt fiber may be a structural dielectric insulator material that may be used independently and/or in conjunction with other fibers and/or fiber types.

Some embodiments provide that a second fabric material 315 is formed on a portion of the first fabric material 310. In some embodiments, the second fabric material 315 is configured to partially wrap around the first fabric material 310 to define an axially extending gap 325 in the second fabric material 315. Some embodiments provide that the fabric material layers may include types of fabrics including woven, stitched, thermal formed, chopped fiber, continuous fiber, and/or paper, natural and synthetic, among others.

Some embodiments include a spiral wrap layer 320 over the second fabric material 315. In some embodiments, the spiral wrap layer 320 includes multiple filament wound hoops.

Some embodiments include a third fabric material 335 that is formed on a portion of the second fabric material 315. In some embodiments, the third fabric material 335 is configured to partially wrap around the second fabric material 315 to define an axially extending gap in the third fabric material 335. In some embodiments, the third fabric material 335 is between the second fabric material 315 and the spiral wrap layer 320. Briefly referring to FIG. 3B, some embodiments do not include the third fabric material 335.

In some embodiments, the axially extending gap 325 in the second fabric material 315 and the axially extending gap 326 in the third fabric material 335 comprise resin. Briefly referring to FIG. 3C, some embodiments provide that the axially extending gap 325 in the second fabric material 315 is aligned with the axially extending gap 326 in the third fabric material 335.

Referring to FIG. 3A, the axially extending gap 325 in the second fabric material 315 at a first radial position and the axially extending gap 330 in the third fabric material is at a second radial position that is different from the first radial position.

Referring to FIG. 3A, some embodiments provide that the axially extending gap 325 in the second fabric material 315 is at a first radial position and the axially extending gap 330 in the third fabric material 335 is at a same radial position as that of the first radial position. Some embodiments provide that there may be about a ½″ or more of layer to layer overlap in order to survive cyclic loading.

In some embodiments, the second fabric material 315 and the third fabric material 335 are configured to define multiple axially extending gaps in the second fabric material 315 and the third fabric material 335. Some embodiments provide that ones of the extending gaps are radially staggered relative to one another.

Referring to FIG. 3D, some embodiments provide that the axially extending gap 325 in the second fabric material 315 at a first radial position and the axially extending gap 326 in the third fabric material 335 partially overlap one another. In some embodiments, the axially extending gap 325 in the second fabric material 315 at a first radial position and the axially extending gap 326 in the third fabric material 335 partially overlap one another in a range from about ¼ inch to about ¾ inch. In some embodiments, gap 325 and 326 may be separated by at least ½″ of fabric to fabric resin bonding between the two gaps.

In some embodiments, the axially extending gap 325 in the second fabric material at a first radial position is covered by a multi-directional tape in a range from about ¾ inch to about 2 inches. Some embodiments provide that the second and third layers each comprises a fabric comprising multidirectionally arranged fiber reinforced resin matrix material.

In some embodiments, the at least one MOV block is a component in a stack that includes a plurality of MOV blocks. In some embodiments, the at least one MOV block is a component in a stack that includes a metallic block.

Some embodiments include a compression layer formed on the second fabric material 315 and/or the third fabric material 335. In some embodiments, the compression layer comprises a compression tape.

Referring to FIG. 3E, some embodiments provide that the axially extending gap 325 in the second fabric material 315 at a first radial position and the axially extending gap 326 in the third fabric material 335 are spaced apart from one another. In some embodiments, the axially extending gap 325 in the second fabric material 315 at a first radial position and the axially extending gap 326 in the third fabric material 335 may be at a second position. In some embodiments, gaps 325 and 326 may be separated by at least ½″ of fabric to fabric resin bonding between the two gaps.

In some embodiments, the axially extending gap 325 in the second fabric material 315 at a first radial position is covered by a multi-directional tape in a range from about ¾ inch to about 2 inches. Some embodiments provide that the second and third layers each comprises a fabric comprising multidirectionally arranged fiber reinforced resin matrix material.

In some embodiments, the at least one MOV block is a component in a stack that includes a plurality of MOV blocks. In some embodiments, the at least one MOV block is a component in a stack that includes a metallic block.

Some embodiments include a compression layer formed on the second fabric material 315 and/or the third fabric material 335. In some embodiments, the compression layer comprises a compression tape.

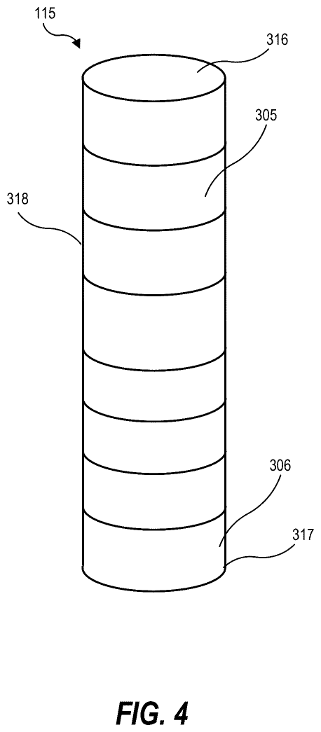

Brief reference is now made to FIG. 4, which is a schematic block diagram illustrating a stack array in a module assembly 115 according to some embodiments. Some embodiments include one or more MOV blocks 305 and/or one or more conductive blocks 306. In some embodiments, the conductive blocks 306 include metal blocks, such as, for example, Aluminum blocks.

Some embodiments provide that the module assembly 115 includes a top surface 316 and a bottom surface 317 that is opposite the top surface 316. Some embodiments provide that the multiple blocks in the stack array define an outer circumferential surface 318 that is between the top and bottom surfaces 316, 317.

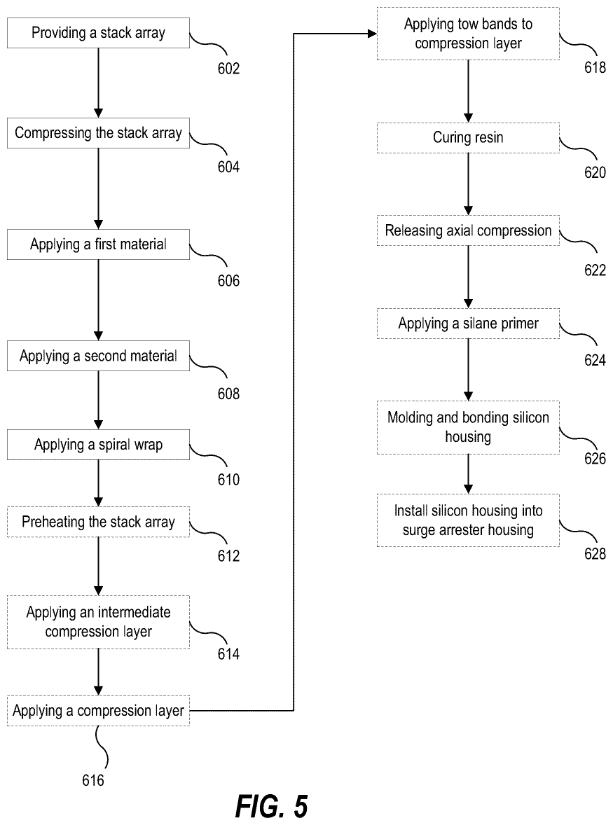

Reference is now made to FIG. 5, which is a block diagram illustrating operations for providing a surge arrester according to some embodiments. Operations include providing (block 602) a stack array that comprises at least one MOV and at least one metallic block that are arranged adjacent one another. In some embodiments, the stack array may form an outer circumferential surface that is arranged between a stack top surface and a stack bottom surface. Operations include compressing (block 604) the stack array by applying an axial compression force at the stack top surface and the stack bottom surface and applying (block 606) a first fabric material to the outer circumferential surface of the stack array, the first fabric material comprises a fabric that includes multiple unidirectional glass fibers that are arranged substantially parallel to one another and axially oriented on module assembly 115. Some embodiments provide that the first fabric may not be included therein.

Operations further include applying (block 608) a second fabric material that is formed on a portion of the first material. Some embodiments provide that the second fabric material is configured to partially wrap around the first fabric material to define an end-to-end axially extending gap in the second fabric material.

Operations may include applying (bock 610) a spiral wrap layer over the second fabric material. In some embodiments, the spiral wrap layer includes multiple filament wound hoops. In some embodiments, the filament wound hoops may be axially spaced apart from one another.

In some embodiments, before applying the first material, the method further comprises preheating (block 612) the stack array. Some embodiments further include applying (block 614) an intermediate compression layer to the first material before applying (block 608) the second fabric material. In some embodiments, the third layer may have a gap staggered from the second layer gap. In such embodiments, material layer may always be included and layers 1 and/or 3 may be optional.

Some embodiments further include applying (block 616) a compression layer to the second fabric material. Some embodiments further include applying (block 618) tow bands to the compression layer.

Some embodiments include curing (block 620) resin in the first material and/or the second fabric material by applying heat to the surge arrester. In some embodiments, after curing the resin, the method further includes releasing (block 622) the axial compression applied to the stack array by removing the axial compression force at the stack top surface and the stack bottom surface.

Some embodiments further include applying (block 624) a silane primer to the compression layer and molding and bonding block 626) a silicon housing to the layers formed on the stack array. Some embodiments include installing (block 628) the silicon housing into a surge arrester housing.

In some embodiments, operations may include at least one of adhesively bonding Ethylene Propylene Diene Monomer (EPDM) to the module assembly, mechanically sealing EPDM to the module assembly, interference fitting EPDM to the module assembly, sealing EPDM to the module assembly, applying a thermal set polymer to the module assembly and/or applying a thermal plastic to the module assembly.

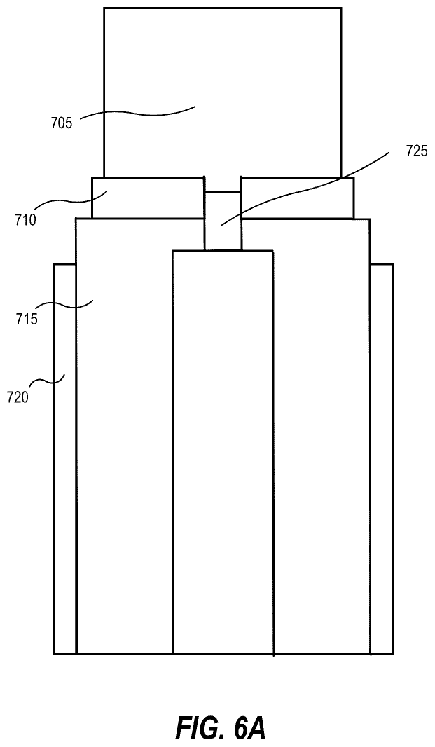

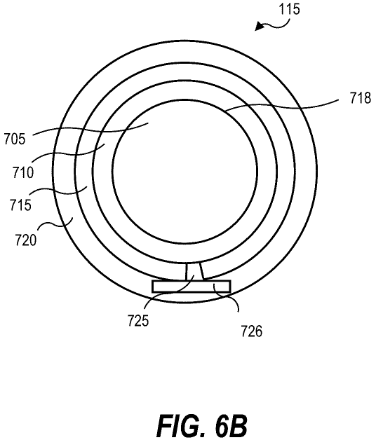

Reference is now made to FIGS. 6A and 6B, which are schematic block diagrams of a cut-away side view and a top view, respectively of a surge arrester according to some embodiments.

Referring to FIGS. 6A and 6B, the surge arrester includes a module assembly 115. An insulating and/or dielectric compound, such as room temperature vulcanized silicone, may fill any voids between the module assembly 115 and the inner surface of any housing.

In some embodiments, a silane surface treatment is applied onto 115 and then high temperature vulcanized (HTV) silicone may be directly molded and bonded to module 115. This approach could also be done using liquid silicone molding (LSR).

In some embodiments, the arrester modules may include molding “logs” of arrester modules. A log according to such embodiments may include 1-10 arrester modules depending on the module size. After molding, the silicone and f/g composite are slit at each module to module interface and separated into individual modules. Therefore, the molded silicone is only encasing the circumferential surface same as the f/g composite. We then use RTV silicone to bond a metal, such as, for example, stainless steel, cap on each end. A terminal stud may be threaded into the module end electrode on each end and retains the metal cap to form a bonded seal. In some embodiments, the RTV may be a gap filler to eliminate entrapped air and also bond the surfaces together.

The surge arrester is connected to a line-potential conductor and to ground. The surge arrester also is connected to electrical equipment protected by the surge arrester. More particularly, an end of the surge arrester comprises an end of the electrical equipment that are both connected to the line-potential conductor. The module assembly 115 may include one or more MOV blocks 705 and/or conductive blocks that are contained within a pre-impregnated composite structure.

The module assembly 115 may include at least one metal oxide varister (MOV) block 705 including an outer circumferential surface 718. In some embodiments, the MOV block 705 may have a geometry of a disc that is substantially cylindrical, a polygon and/or a rectilinear block, among others.

Some embodiments provide that a first fabric material 710 is formed onto the outer circumferential surface 718 and includes a fabric that includes multiple unidirectional glass fibers that are arranged substantially parallel to one another and extend from the bottom to the top. In some embodiments, after the first fabric is applied, multiple layers of compression tape may be applied. For example, in some embodiments, 6-8 layers of compression tape may be applied. In some embodiments, a Basalt fiber may be a structural dielectric insulator material that may be used independently and/or in conjunction with other fibers and/or fiber types.

Some embodiments provide that a second fabric material 715 is formed on a portion of the first fabric material 710. In some embodiments, the second fabric material 715 is configured to partially wrap around the first fabric material 710 to define an axially extending gap 725 in the second fabric material 715. Some embodiments provide that the fabric material layers may include types of fabrics including woven, stitched, thermal formed, chopped fiber, continuous fiber, and/or paper, natural and synthetic, among others.

Some embodiments include a compressing resin coating layer and spiral wrap layer 720 over the second fabric material 715. In some embodiments, the spiral wrap layer 720 includes multiple filament wound hoops. In some embodiments, a multiaxial venting layer 736 may be applied proximate the gap area 725 that is filled with epoxy or other type resin.

In the above-description of various embodiments of the present disclosure, it is to be understood that the terminology used herein is for the purpose of describing particular embodiments only and is not intended to be limiting of the disclosure. Unless otherwise defined, all terms (including technical and scientific terms) used herein have the same meaning as commonly understood by one of ordinary skill in the art to which the embodiments of the disclosure belong. It will be further understood that terms, such as those defined in commonly used dictionaries, should be interpreted as having a meaning that is consistent with their meaning in the context of this specification and the relevant art.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Blocks that are illustrated using dashed lines may be considered optional and may correspond to different ones of the plurality of embodiments described herein.

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the disclosure. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of the disclosure. Accordingly, the above disclosed subject matter is to be considered illustrative, and not restrictive, and the examples of embodiments are intended to cover all such modifications, enhancements, and other embodiments, which fall within the spirit and scope of the disclosure. Thus, to the maximum extent allowed by law, the scope of the disclosure are to be determined by the broadest permissible interpretation of the present disclosure including the examples of embodiments and their equivalents, and shall not be restricted or limited by the foregoing detailed description.

What is claimed is:

1. A surge arrester comprising:
a module assembly comprising at least one metal oxide varister (MOV) block including a top surface, a bottom surface that is opposite the top surface, and an outer circumferential surface between the top and bottom surfaces;
a first fabric material that is formed onto the outer circumferential surface and that comprises a fabric that comprises plurality of unidirectional glass fibers that are arranged substantially parallel to one another and extend from the bottom surface to the top surface; and
a second fabric material that is formed on a portion of the first material, wherein the second fabric material is configured to partially wrap around the first fabric material to define an axially extending gap in the second fabric material.

2. The surge arrester of claim 1, further comprising a spiral TOW wrap layer over the second fabric material, wherein the spiral TOW wrap layer comprises a plurality of filaments in a TOW bundle.

3. The surge arrester of claim 2, further comprising a third fabric material that is formed on a portion of the second fabric material, wherein the third fabric material is configured to partially wrap around the second fabric material to define an axially extending gap in the third fabric material, wherein the third fabric material is between the second fabric material and the spiral wrap layer.

4. The surge arrester of claim 3, wherein the axially extending gap in the second fabric material and the axially extending gap in the third fabric material comprise resin.

5. The surge arrester of claim 3, wherein the axially extending gap in the second fabric material is aligned with the axially extending gap in the third fabric material.

6. The surge arrester of claim 3, wherein the axially extending gap in the second fabric material at a first radial position and the axially extending gap in the third fabric material is at a second radial position that is different from the first radial position.

7. The surge arrester of claim 3, wherein the axially extending gap in the second fabric material at a first radial position and the axially extending gap in the third fabric material is at a same radial position as that of the first radial position.

8. The surge arrester of claim 3, wherein the second fabric material and the third fabric material are configured to define a plurality of axially extending gaps in the second fabric material and the third fabric material, and
wherein ones of the plurality of extending gaps are radially staggered relative to one another.

9. The surge arrester of claim 3, wherein the axially extending gap in the second fabric material at a first radial position and the axially extending gap in the third fabric material partially overlap one another.

10. The surge arrester of claim 9, wherein the axially extending gap in the second fabric material at a first radial position and the axially extending gap in the third fabric material are shifted from one another in a range from about ¼ inch to about ¾ inch.

11. The surge arrester of claim 3, wherein the axially extending gap in the second fabric material at a first radial position is covered by a multi-directional tape in a range from about ¾ inch to about 2 inches.

12. The surge arrester of claim 3, wherein the second and third layers each comprises a fabric comprising multidirectionally arranged fiber reinforced resin matrix material.

13. The surge arrester of claim 1, wherein the at least one MOV block is a component in a stack that includes a plurality of MOV blocks.

14. The surge arrester of claim 1, wherein the at least one MOV block is a component in a stack that includes a metallic block.

15. The surge arrester of claim 2, further comprising a compression layer formed on the second fabric material and/or the third fabric material.

16. The surge arrester of claim 15, wherein the compression layer comprises a compression tape.

17. The surge arrester of claim 16, wherein the tape comprises a fabric and/or perforated tape that is configured to provide a compression force and to be encapsulated by the resin.

18. The surge arrester of claim 1, wherein the plurality of unidirectional glass fibers comprise basalt fibers.

19. The surge arrester of claim 1, comprising at least one surface treated metallic block, wherein surface treatment is achieved by chemical etching or laser etching.

20. The surge arrester of claim 19, wherein the at least one surface treated metallic block comprises surface treated conductive metal end electrodes to improve cyclic loading strength.

21. A method of providing a surge arrester comprising:
a providing a stack array that comprises at least one MOV and at least one metallic block that are arranged adjacent one another to form an outer circumferential surface between a stack top surface and a stack bottom surface;
compressing the stack array by applying an axial compression force at the stack top surface and the stack bottom surface;
applying a first fabric material to the outer circumferential surface of the stack array, the first fabric material comprising a fabric that comprises a plurality of unidirectional glass fibers that are arranged substantially parallel to one another and end to end;
applying a second fabric material that is formed on a portion of the first fabric material, the second fabric material is configured to partially wrap around the first fabric material to define an end-to-end axially extending gap in the second fabric material; and
applying a spiral wrap layer over the second fabric material, wherein the spiral wrap layer comprises a plurality of filament wound hoops.

22. The method of claim 21, wherein before applying the first fabric material, the method further comprises preheating the stack array.

23. The method of claim 21, further comprising applying an intermediate compression layer to the first fabric material before applying the second fabric material.

24. The method of claim 23, wherein a plurality of compression layers and a plurality of first fabric material layers are alternatively applied.

25. The method of claim 23, further comprising:
applying a first plurality of Basalt unidirectional layers;
applying a first compression wrap to an outside surface of the first plurality of Basalt unidirection layers;
applying a second plurality of Basalt unidirectional layers to the first compression wrap; and
applying a second compression wrap to an outside surface of the second plurality of basalt unidirectional layers.

26. The method of claim 25, further comprising: applying a plurality of multidirectional layers to the second compression wrap; and
applying a third compression wrap to the plurality of multidirectional layers.

27. The method of claim 21, further comprising applying a compression layer to the second fabric material.

28. The method of claim 24, applying tow bands to the compression layer.

29. The method of claim 25, wherein the TOW bands comprise Basalt fibers.

30. The method of claim 21, further comprising curing resin in the first fabric material and/or the second fabric material by applying heat to the surge arrester.

31. The method of claim 30, after curing the resin, the method further comprising releasing the axial compression applied to the stack array by removing the axial compression force at the stack top surface and the stack bottom surface.

32. The method of claim 21, further comprising:
applying a silane primer to the compression layer; and
molding and bonding a silicon housing to the layers formed on the stack array.

33. The method of claim 32, further comprising direct molding the silicon housing into a surge arrester.

34. The method of claim 21, further comprising at least one of adhesively bonding Ethylene Propylene Diene Monomer (EPDM) to the module assembly, mechanically sealing EPDM to the module assembly, interference fitting EPDM to the module assembly, sealing EPDM to the module assembly, applying a thermal set polymer to the module assembly and/or applying a thermal plastic to the module assembly.

35. The method of claim 21, wherein the first fabric material comprises Basalt fibers.

36. The method of claim 21, wherein compressing the stack array by applying the axial compression force at the stack top surface and the stack bottom surface comprises applying an initial preload pressure in a range from about 2400 p.s.i. to about 2800 p.s.i.

37. The method of claim 36, wherein the initial preload pressure is about 2600 p.s.i.

38. The method of 36, wherein compressing the stack array by applying the axial compression force at the stack top surface and the stack bottom surface comprises reducing the preload pressure to be in a range of about 870 p.s.i. to about 1070 p.s.i.

39. The method of claim 38, wherein a reduced preload pressure is about 970 p.s.i.

40. The method of claim 21, further comprising:
applying a surface treating to the at least one metallic block through use of chemical etch or laser etch.

41. The method of claim 40, wherein the at least one surface treated metallic block comprises surface treated conductive metal end electrodes.

42. A surge arrester comprising:
a module assembly comprising at least one metal oxide varistor (MOV) block including a top surface, a bottom surface that is opposite the top surface, and an outer circumferential surface between the top and bottom surfaces; and
a first fabric material that is formed on a portion of the outer circumferential surface,
wherein the first fabric material is configured to partially wrap around the outer circumferential surface to define an axially extending gap in the first fabric material, and
wherein the first fabric material comprises multidirectionally arranged fiber reinforced resin matrix material.

43. The surge arrester of claim 42, further comprising a second fabric material that is formed on a portion of the first fabric material, wherein the second fabric material is configured to partially wrap around the first fabric material to define an axially extending gap in the second fabric material, wherein the second fabric material is between the first fabric material and a spiral wrap layer.

44. The surge arrester of claim 43, further comprising a third fabric material that is formed on a portion of the second fabric material, wherein the third fabric material is configured to partially wrap around the second fabric material to define an axially extending gap in the third fabric material, wherein the third fabric material is between the second fabric material and the spiral wrap layer.

45. The surge arrester of claim 44, further comprising a compression material that is encapsulated by the multidirectionally arranged fiber reinforced resin matrix material.

46. The surge arrester of claim 44, wherein at least one of the first fabric material, the second fabric material and the third fabric material comprise woven polypropylene having fused edges.

47. The surge arrester of claim 44, wherein at least one of the first fabric material, the second fabric material and the third fabric material comprises about 0.005″ woven polypropylene.

48. The surge arrester of claim 44, wherein at least one of the first fabric material, the second fabric material and the third fabric material is configured to shrink in a range of about 0.5% to about 7.0%, at about a minimum viscosity temperature of an epoxy resin in the first fabric material, the second fabric material and/or the third fabric material.

49. The surge arrester of claim 42, comprising at least one surface treated metallic block, wherein surface treatment is achieved by chemical etching or laser etching.

50. The surge arrester of claim 49, wherein the at least one surface treated metallic block comprises surface treated conductive metal end electrodes to improve cyclic loading strength.
